(19) United States
(12) Patent Application Publication
(10) Pub. No.: US 2018/0359207 A1
(43) Pub. Date: Dec. 13, 2018

(54) SUPPRESSING THE DISPLAY OF NOTIFICATIONS ON USER DEVICES BASED ON USER DEVICE ACTIVITY

(71) Applicant: INTERNATIONAL BUSINESS MACHINES CORPORATION, Armonk, NY (US)

(72) Inventors: Avijit Chatterjee, White Plains, NY (US); Jagannadharao V. Dusi, Poughkeepsie, NY (US)

(21) Appl. No.: 15/617,177

(22) Filed: Jun. 8, 2017

(51) Int. Cl. H04L 12/58; H04L 29/08; H04W 4/14; G06K 9/00

(52) U.S. Cl. CPC H04L 51/24; H04L 67/22; H04L 51/22; G06F 3/0481; H04W 4/14; G06K 9/00288; H04L 51/04

(57) ABSTRACT

A computer-implemented method includes monitoring, by a user device, activity associated with the user device; detecting, by the user device, an event for activating a notification suppression mode based on the monitoring, wherein the event relates to viewing of content displayed by the user device by another user other than a primary user of the user device; receiving, by the user device, a communication; and suppressing, by the user device, a notification for the communication based on detecting the event for activating the notification suppression mode.

### BACKGROUND

The present invention generally relates to suppressing the display of notifications on user devices and, more particularly, to suppressing the display of notifications based on user device activity and/or other criteria.

User devices, such as laptops, desktops, tablets, smart phones, etc., may receive various types of communications (e.g., e-mails, text messages, instant messages, etc.). A user device may provide a visual notification on the display of the user device to notify a user that a communication has been received. For example, the user device may provide a “pop-up” notification in which a preview image or first few text lines of a communication are shown in a corner of the display, top of the display, etc. The user may select the notification to view the entirety of the communication within an application that received the communication (e.g., an e-mail application, instant messaging application, etc.). A pop-up notification may be automatically provided so that the user has immediate notification of the communication and to provide a level of convenience for allowing the user to view and respond to the communication quickly.

### SUMMARY

In an aspect of the invention, a computer-implemented method includes: monitoring, by a user device, activity associated with the user device; detecting, by the user device, an event for activating a notification suppression mode based on the monitoring, wherein the event relates to viewing of content displayed by the user device by another user other than a primary user of the user device; receiving, by the user device, a communication; and suppressing, by the user device, a notification for the communication based on detecting the event for activating the notification suppression mode.

In an aspect of the invention, there is a computer program product for suppressing notifications. The computer program product comprises a computer readable storage medium having program instructions embodied therewith, the program instructions are executable by a computing device to cause the computing device to: monitor activity associated with the user device; detect, without user interaction, an event for suppressing notifications based on the monitoring, wherein the event relates to viewing of content displayed by the user device by another user other than a primary user of the user device; receive a communication; and suppress a notification for the communication based on the detecting the event for suppressing notifications.

In an aspect of the invention, a system includes: a CPU, a computer readable memory and a computer readable storage medium associated with a user device; program instructions to monitor imaging data from one or more camera devices connected to the user device; program instructions to detect that a non-primary user is viewing a display through which the user device is displaying content; and program instructions to suppress notifications of incoming communications based on detecting that the non-primary user is viewing the display. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example implementation in accordance with aspects of the present invention

FIG. 5 shows an example environment in accordance with aspects of the present invention.

FIG. 6 shows a block diagram of example components of a notification suppression component in accordance with aspects of the present invention.

FIGS. 7A and 7B show an example flowchart for automatically activating, pausing, and deactivating a notification suppression mode without user interaction in accordance with aspects of the present invention.

### DETAILED DESCRIPTION

The present invention generally relates to suppressing the display of notifications on user devices and, more particularly, to suppressing the display of notifications based on user device activity and/or other criteria. While notifications (e.g., pop-up notifications, or the like) provide immediate notification of a received communication, such notifications may compromise privacy. For example, a notification of a communications (e.g., an e-mail, text message, instant message, etc.) may be received and displayed abruptly, without any sort of warning or advance notice to the user. In the event the user device is displaying content to an audience that includes other individuals aside from the user (e.g., when the user device is being used to present content to an audience or during a “screen sharing” mode in which the display of the user device is being shared with another user device through a screen sharing application), a situation may arise in which a pop-up notification is displayed and hence, viewed by the audience or by a participant in a screen sharing communication. Such a situation can be problematic when the notification includes private or sensitive information (e.g., a communication of a personal nature, or having proprietary information). Accordingly, aspects of the present invention include a system for monitoring the activity of a user device, and detecting when the display of notifications of communications should be suppressed based on the user activity (e.g., when the user device is in a presentation mode, screen sharing mode, etc.). Further, aspects of the present invention may suppress the notifications, detect when notifications should be resumed (e.g., when the presentation or screen sharing mode has been disabled), and resume providing notifications.

As described herein, aspects of the present invention may detect a suppression event (e.g., an event that triggers a function to suppress the display of notifications) based on the satisfaction of a variety of customizable criteria. As an example, aspects of the present invention may detect a suppression event when an application (e.g., a presentation application) is set to a presentation mode. Additionally, or alternatively, a suppression event may correspond to when the user device is outputting video data through a particular output (e.g., an output that has been designated or assigned to an external display, such as a projector). Additionally, or alternatively, a suppression event may correspond to when an application running in a foreground of the user device is set to a “full screen” mode. Additionally, or alternatively, a suppression event may be identified based on a user's calendar (e.g., when the user's calendar indicates that the user will be presenting to an audience).

In embodiments, a suppression event may be identified based on content displayed by the user device. For example, aspects of the present invention may determine that the user is likely presenting content to an audience based on the content being displayed by the user device. In embodiments, aspects of the present invention may analyze text and/or objects, and determine that the text and/or objects is consistent with predefined parameters defining presentation content (e.g., when the displayed content includes text and/or objects arranged in a manner that is consistent with a presentation and are presented in a full screen layout). Based on detecting the display of presentation content in a full screen layout, aspects of the present invention may detect a suppression event and toggle a notification suppression mode.

In embodiments, aspects of the present invention may detect the suppression event based on image data captured by a camera device of the user device (e.g., a front-facing camera). For example, aspects of the present invention may determine that an individual other than the primary user is viewing the user device display, or that multiple users are viewing the user device display.

In embodiments, aspects of the present invention may intercept a communication, analyze the content of the communication, and suppress a notification of the communication based on the content of the communication (e.g., when the communication includes content, such as words or images, that are consistent with parameters that have been defined as sensitive). Aspects of the present invention may also provide information indicating a status of the suppression mode (e.g., whether the suppression mode is active, paused, or inactive) to an application server (e.g., an e-mail server, instant message application server, etc.). In embodiments, other users may view the suppression mode status (e.g., via an instant messaging application, or the like).

Aspects of the present invention improve privacy and security of sensitive information by preventing communication notifications having private and/or sensitive matter from being abruptly displayed when other individuals (aside from the intended recipient of the communication) are viewing displayed content. In embodiments, notifications may be suppressed altogether. Alternatively, notifications may be modified so as to conceal any sensitive information. For example, the notification may be displayed but with the private or sensitive information being concealed.

In embodiments, the notifications may be suppressed without requiring the user to manually set a suppression mode. For example, the suppression mode may be set automatically based on user device activity and/or other the detection of other criteria, as described herein. Further, existing applications need not be re-written or updated since aspects of the present invention may toggle the suppression mode based on normal user activity and without receiving any special or specific instructions from applications or operating systems.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

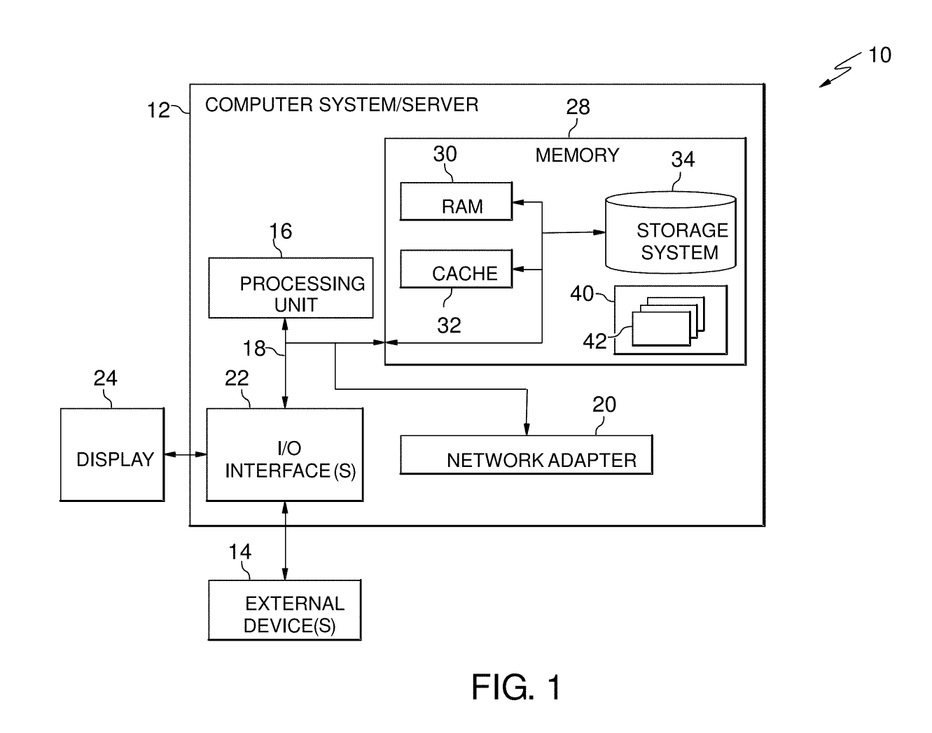

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

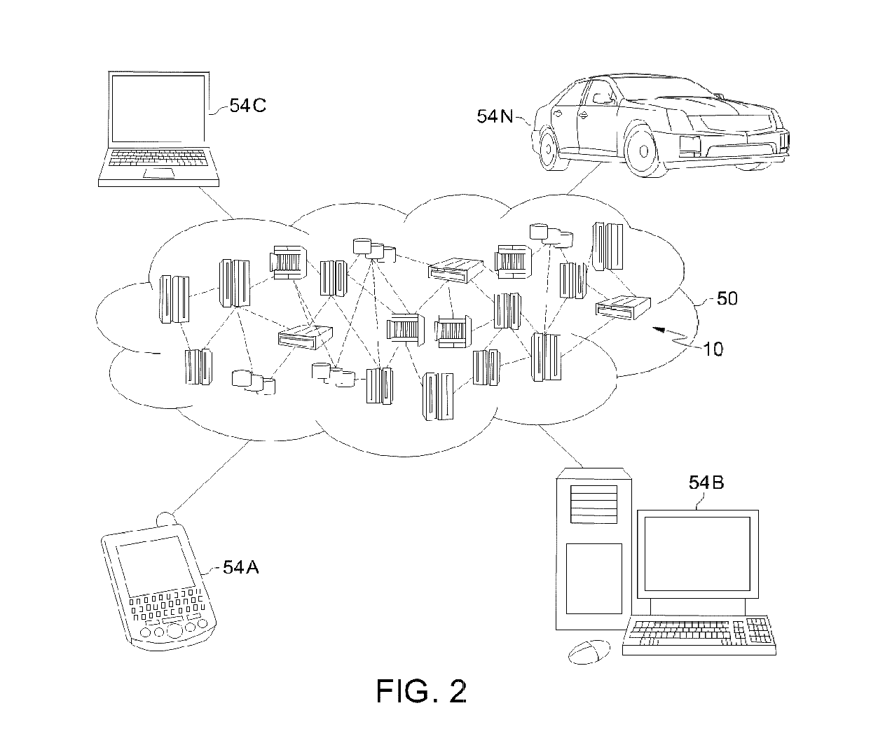

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

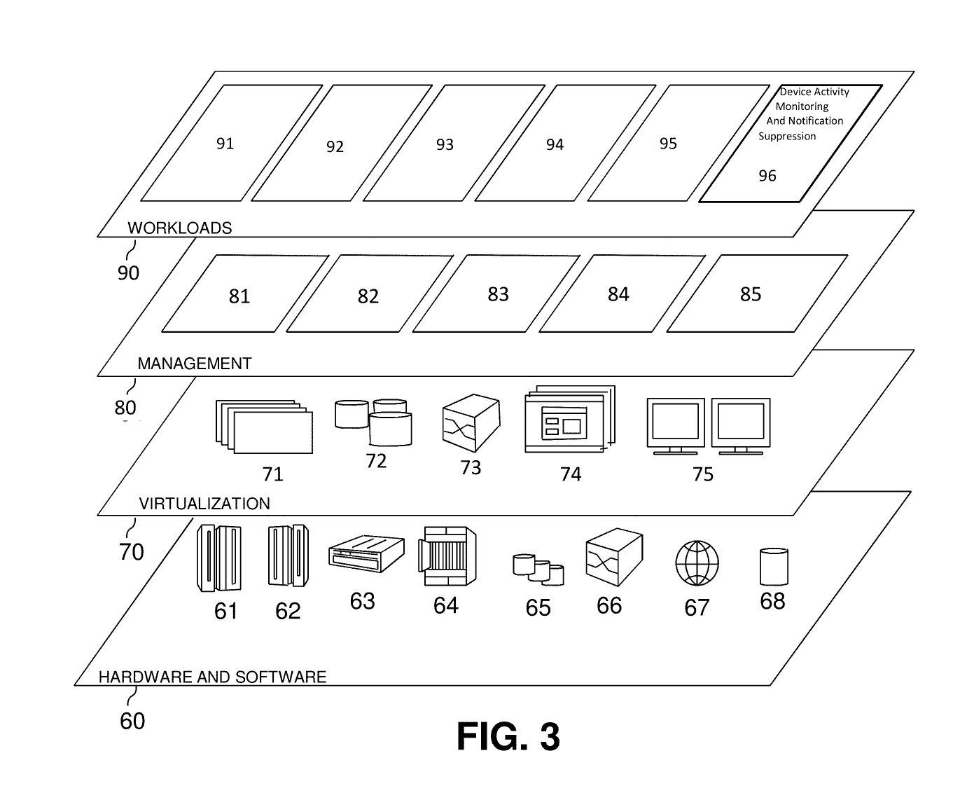

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and device activity monitoring and notification suppression 96.

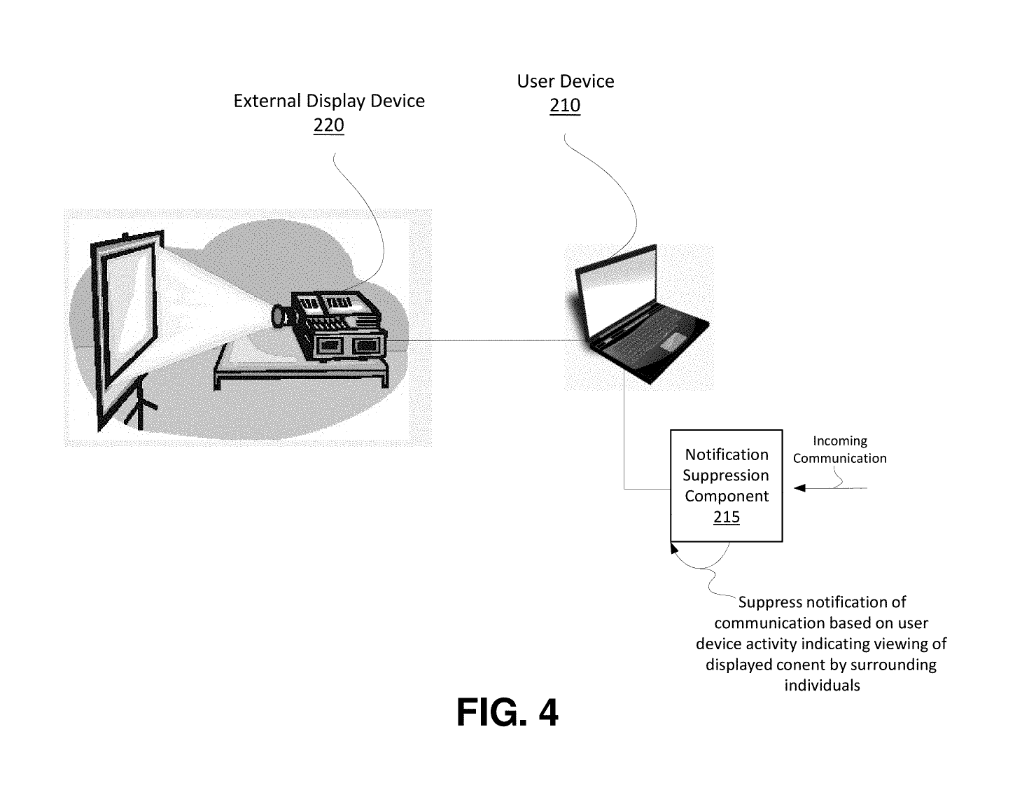

Referring back to FIG. 1, the program/utility 40 may include one or more program modules 42 that generally carry out the functions and/or methodologies of embodiments of the invention as described herein (e.g., such as the functionality provided by device activity monitoring and notification suppression 96). Specifically, the program modules 42 may monitor user device activity, detect an event for activating notification suppression (e.g., an event in which the display output of the user device is being viewed by individuals other than the recipient of a communication), receive a communication that triggers a notification, suppress the notification, detect an event for deactivating notification suppression based on continued monitoring of the user device activity, and discontinue suppressing communication notifications. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of a notification suppression component as shown in FIG. 4.

FIG. 4 shows an overview of an example implementation in accordance with aspects of the present invention. As shown in FIG. 4, a user device 210 may include a notification suppression component 215. As described herein, the notification suppression component 215 may monitor user device activity and may enable a notification suppression mode based on detecting an event that indicates that content displayed by the user device 210 is being viewed by surrounding individuals (e.g., audience members of a presentation). Based on detecting such an event, the notification suppression component 215 may suppress a notification of an incoming communication (e.g., an e-mail, text message, instant message, etc.). In this way, surrounding individuals may not see private and/or sensitive information that may have been viewable via the notification.

As an illustrative example, the notification suppression component 215 may enable a notification suppression mode based on detecting that the user device 210 is displaying content to an external display device 220 (e.g., a projector). In embodiments, the notification suppression component 215 may store criteria that stipulate that the suppression mode should be enabled when the user device 210 is displaying content via a particular output (e.g., via an output that is assigned to an external display device 220). As described herein, the criteria may be user customizable since different users may use different outputs for connecting an external display 220 for displaying content to an audience. In embodiments, the criteria may stipulate that the notification suppression mode be enabled when the user device 210 is displaying to external displays 220 of a particular model number or type. For example, a video manager of an operating system running on a user device 210 may identify a model number of an external display through a standard interface, such as a video graphics array (VGA) interface, digital visual interface (DVI), high definition multimedia interface (HDMI) or the like. The notification suppression component 215 may access information identifying the model number via an API call with the video manager of the operating system. Alternatively, the notification suppression component 215 may itself implement a video manager that obtains information regarding a connected external display. Accordingly, the notification suppression component 215 may enable a notification suppression mode when the user device 210 is connected to a projector-type external display device 220, and may suppress notifications of incoming communications.

Additionally, or alternatively, the notification suppression component 215 may enable the notification suppression mode by monitoring application activity. For example, the notification suppression component 215 may enable the notification suppression mode based on determining that a presentation mode has been enabled in a presentation application. Additionally, or alternatively, the notification suppression component 215 may enable the notification suppression mode based on determining that an application has entered a full-screen mode (e.g., indicating that the content of the application is being presented to an audience). In embodiments, the notification suppression component 215 may monitor the activity of an operating system and/or other applications via API calls. As is described in additional detail herein, the notification suppression component 215 may enable the notification suppression mode based on detecting the satisfaction of other criteria.

In embodiments, the notification suppression component 215 may continue to monitor the activity of user device 210 and may temporarily pause or discontinue the notification suppression mode (e.g., when the user device 210 discontinues displaying content through a projector, when an application is no longer in presentation or full-screen mode, etc.). As described herein, the status of the notification suppression mode may be provided to an application server that hosts, for example, an instant messaging application so that other users may be aware that the user may not be available to immediately respond to a communication when the notification suppression mode is enabled (e.g., when the user is presenting or otherwise unavailable to respond to communications). In embodiments, the notification suppression component 215 may provide an automated reply to an incoming communication to notify the sender of the communication the recipient may not be immediately available to respond to the communication.

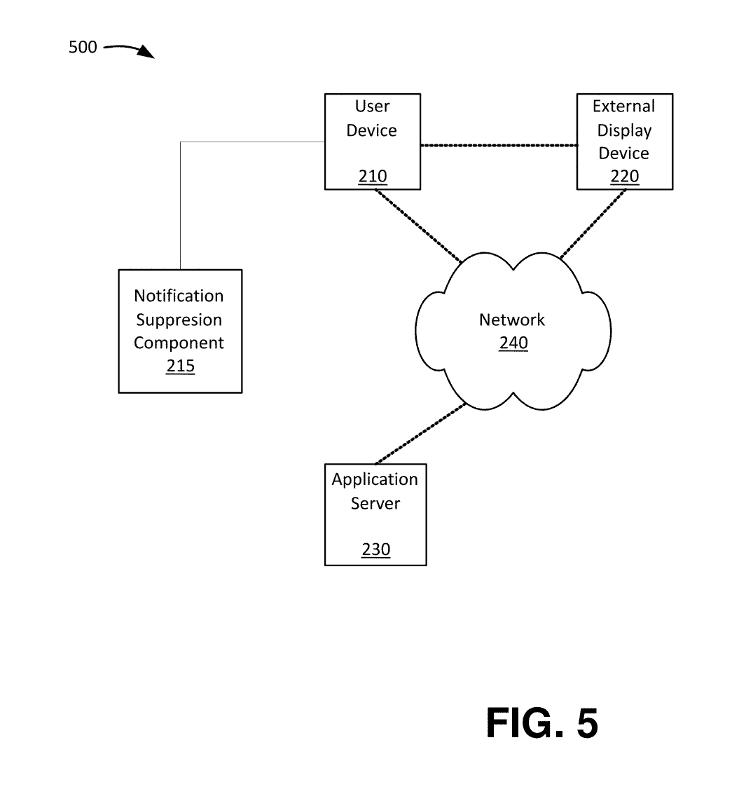

FIG. 5 shows an example environment in accordance with aspects of the present invention. As shown in FIG, 5, environment 500 may include a user device 210, an external display device 220, an application server 230, and/or network 240. In embodiments, one or more components in environment 500 may correspond to one or more components in the cloud computing environment of FIG. 2. In embodiments, one or more components in environment 500 may include the components of computer system/server 12 of FIG. 1.

The user device 210 may include a computing device capable of communicating via a network, such as the network 240. For example, the user device 210 may correspond to a mobile communication device (e.g., a smart phone or a personal digital assistant (PDA)), a portable computer device (e.g., a laptop or a tablet computer), a desktop computing device, or another type of computing device. In embodiments, the user device 210 may include a notification suppression component 215 that monitors activity of user device 210. As described herein, the notification suppression component 215 may enable a notification suppression mode based on detecting the satisfaction of criteria that define a situation in which surrounding individuals (e.g., audience members) may be viewing content displayed by the user device 210.

The external display device 220 may include a display device that may be connected to display content output via a video interface of the user device 210. As described herein, the external display device 220 may output data representing the type and model number of the external display device 220. The notification suppression component 215 may use the type and/or model number to as part of a determination as to whether the notification suppression mode should be enabled or activated.

The application server 230 may include one or more computing devices (e.g., such as computer system/server 12 of FIG. 1) that hosts an application service, such as an instant messaging service. In embodiments, the application server 230 may receive information regarding the notification suppression mode status of a user device 210. An instant messaging application may display the notification suppression mode in the form of a colored and/or patterned icon for identification of the notification suppression mode.

The network 240 may include network nodes, such as network nodes 10 of FIG. 2. Additionally, or alternatively, the network 240 may include one or more wired and/or wireless networks. For example, the network 240 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 240 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 500 is not limited to what is shown in FIG. 5. In practice, the environment 500 may include additional devices and/or networks; fewer devices and/or networks; different devices and/or networks; or differently arranged devices and/or networks than illustrated in FIG. 5. Also, in some implementations, one or more of the devices of the environment 500 may perform one or more functions described as being performed by another one or more of the devices of the environment 500. Devices of the environment 500 may interconnect via wired connections, wireless connections, or a combination of wired and wireless connections.

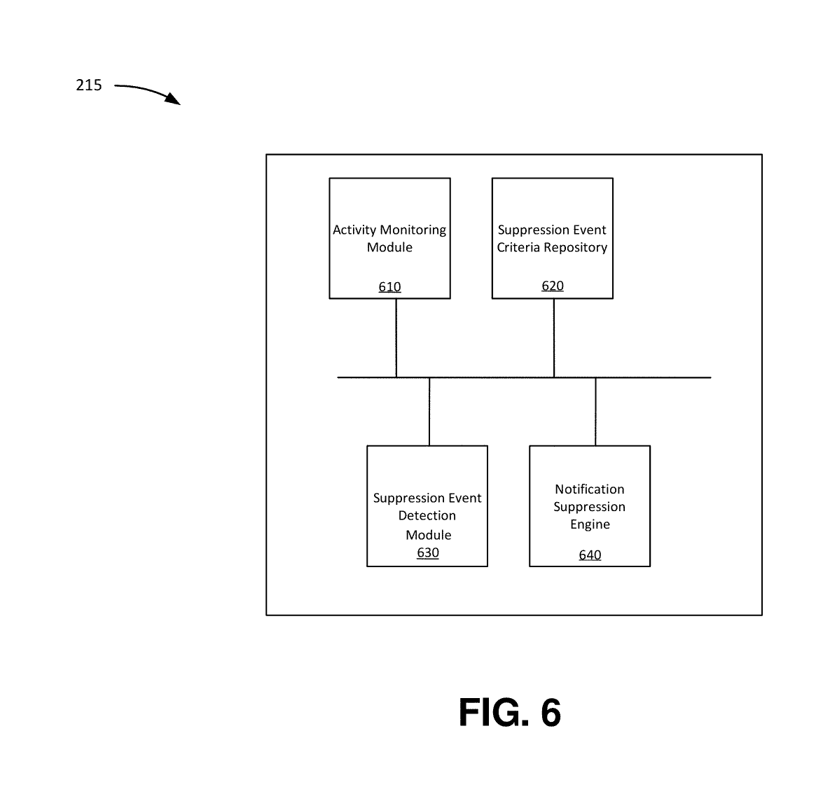

FIG. 6 shows a block diagram of example components of a notification suppression component in accordance with aspects of the present invention. As shown in FIG. 6, the notification suppression component 215 may include an activity monitoring module 610, a suppression event criteria repository 620, a suppression event detection module 630, and a notification suppression engine 640. In embodiments, the notification suppression component 215 may include additional or fewer components than those shown in FIG. 6. In embodiments, separate components may be integrated into a single computing component or module. Additionally, or alternatively, a single component may be implemented as multiple computing components or modules.

The activity monitoring module 610 may include a program module (e.g., program module 42 of FIG. 1) that monitors device activity of user device 210. In particular, activity monitoring module 610 may monitor the interface with which user device 210 is outputting content and may monitor the type and/or model number of a display through which content is being output (e.g., by communicating with the video manager of the user device 210). Additionally, or alternatively, the activity monitoring module 610 may monitor application activity, such as the presentation mode status of a presentation application. Additionally, or alternatively, the activity monitoring module 610 may monitor the status of a full-screen mode within an application. In embodiments, the activity monitoring module 610 may monitor imaging data received from one or more camera devices of user device 210. For example, the activity monitoring module 610 may monitor imaging data from a front-facing camera (e.g., a camera mounted on or in a display of user device 210 such that the camera captures images of faces of users that are in front of the display of user device 210). As described herein, the imaging data may indicate whether surrounding individuals are viewing the display of user device 210, and may indicate whether another user, other than a primary user of the user device 210 (e.g., a registered user, owner, etc), is viewing the display of user device 210. In embodiments, the activity monitoring module 610 may monitor mouse and/or keyboard inputs that indicate whether the user is idle. In embodiments, the activity monitoring module 610 may monitor content output by the user device 210 using object recognition, text recognition, pattern recognition, pixel-based classification, or the like.

The suppression event criteria repository 620 may include a data storage device (e.g., storage system 34 of FIG. 1) that store criteria stipulating conditions under which the notification suppression mode should be activated, paused, and deactivated. The criteria for activating the notification suppression mode may identify conditions corresponding to an event or situation in which an individual, other than the primary user of user device 210, is viewing content displayed by the user device 210. As described herein, the suppression event criteria repository 620 may store criteria that stipulate that the notification suppression mode should be activated when the user device 210 is displaying content via a particular interface (e.g., an interface that has been defined as one corresponding to a projector or similar display in which audience members may be viewing the content). Additionally, or alternatively, the suppression event criteria repository 620 may store criteria that stipulate that the notification suppression mode should be activated when the user device 210 is displaying content via a particular external display 220 of having of a particular type or model number (e.g., a projector type display). Additionally, or alternatively, the suppression event criteria repository 620 may store criteria that stipulate that the notification suppression mode should be activated when the user device 210 is displaying content in a full-screen or presentation mode within an application.

Additionally, or alternatively, the suppression event criteria repository 620 may store criteria that stipulate that the notification suppression mode should be activated based on the arrangement of objects/texts displayed by the user device 210. For example, the suppression event criteria repository 620 may store criteria that stipulate that the notification suppression mode should be activated based on text and objects being arranged in a particular manner indicating that the user device 210 is being used to present content to an audience (e.g., when text and objects are arranged in a manner that is consistent with parameters defining a full-screen presentation). Additionally, or alternatively, the suppression event criteria repository 620 may store criteria that stipulate that the notification suppression mode should be activated when a “screen sharing” mode is active (e.g., when the display of user device 210 is being shared over with another user device 210 though a screen sharing application or remote desktop connection).

In embodiments, the suppression event criteria repository 620 may store criteria that stipulate that the notification suppression mode should be activated when the user has been idle for a threshold amount of time. Additionally, or alternatively, the suppression event criteria repository 620 may store criteria that stipulate that the notification suppression mode should be activated based on camera or imaging data from a front-facing camera indicating that multiple users are viewing a display connected to the user device 210. Additionally, or alternatively, the suppression event criteria repository 620 may store criteria that stipulate that the notification suppression mode should be activated based on camera or imaging data from a front-facing camera indicating that a non-primary user is viewing the display connected to the user device 210. Additionally, or alternatively, the suppression event criteria repository 620 may store criteria that stipulate that the notification suppression mode should be activated based on calendar events that indicate that the user of user device 210 may be presenting to an audience. Additionally, or alternatively, the suppression event criteria repository 620 may store criteria that stipulate that the notification suppression mode should be activated based on some other condition.

In embodiments, the suppression event criteria repository 620 may store criteria that stipulate that the notification suppression mode should be temporarily paused in which notifications are provided for a short period of time before the notification suppression mode is again reactivated. For example, the suppression event criteria repository 620 store criteria that stipulate that the notification suppression mode should be temporarily paused during a break period of a presentation. In embodiments, the break period of a presentation may be determined based on calendar information and/or when user activity becomes idle during a time when the notification suppression mode is active. Additionally, or alternatively, the break period of the presentation may be determined based on text and/or objects included in a presentation displayed by the user device 210 (e.g., text indicating a break period).

In embodiments, the suppression event criteria repository 620 may store criteria that stipulate when the notification suppression mode should be deactivated or disabled. For example, the suppression event criteria repository 620 may store criteria that stipulate that the notification suppression mode should be deactivated when a presentation ends (e.g., when a presentation or full-screen mode has been discontinued). In general, the suppression event criteria repository 620 may store criteria that stipulate that the notification suppression mode should be deactivated when the conditions under which the notification suppression mode was activated are no longer true (e.g., when content is no longer displayed through an interface assigned to a projector display, when content is no longer displayed via an external display of a particular type/model number, etc.).

The suppression event detection module 630 may include a program module (e.g., program module 42 of FIG. 1) that detects a suppression event (e.g., an event in which the notification suppression mode should be activated, paused, and deactivated). In embodiments, the suppression event detection module 630 may detect that the notification suppression mode should be activated based on comparing device activity monitoring information (e.g., from the activity monitoring module 610) with the criteria stored by the suppression event criteria repository 620 that stipulate the conditions under which the notification suppression mode should be activated. As an illustrative example, the suppression event detection module 630 may identify that content is being displayed through an interface assigned to a projector or through a display having a model number as a projector. Further, the suppression event detection module 630 may identify (e.g., based on information stored by the suppression event criteria repository 620) that the notification suppression mode should be activated when content is being displayed through an interface assigned to a projector or through a display having a model number as a projector. Accordingly, the suppression event detection module 630 may detect a suppression event in which the notification suppression mode should be activated.

In embodiments, the suppression event detection module 630 may use facial recognition techniques to determine whether to activate the notification suppression mode (e.g., when the device monitoring information from activity monitoring module 610 includes image data and when the criteria from suppression event criteria repository 620 stipulates that an unrecognized face should trigger the notification suppression mode). In embodiments, the suppression event detection module 630 may use natural language processing techniques to identify breaks in a presentation and determine that the notification suppression mode should be paused based on criteria stipulating that text indicating a break in the presentation should pause the notification suppression mode. In general, the suppression event detection module 630 may detect a suppression event defining when the notification suppression mode should be activated based on comparing device monitoring information (from activity monitoring module 610) with criteria information (from the suppression event criteria repository 620) and detecting when the device monitoring information satisfies the criteria for activating the notification suppression mode. Similarly, the suppression event detection module 630 may detect a suppression event defining when the notification suppression mode should be paused or deactivated based on comparing device monitoring information (from activity monitoring module 610) with criteria information (from the suppression event criteria repository 620) and detecting when the device monitoring information satisfies the criteria for pausing or deactivating the notification suppression mode.

The notification suppression engine 640 may include a program module (e.g., program module 42 of FIG. 1) that receives instructions from the suppression event detection module 630 to activate, pause, or deactivate the notification suppression mode. When receiving an instruction to activate the notification suppression mode, the notification suppression engine 640 may suppress notifications for a duration in which the notification suppression mode is active. In particular, the notification suppression engine 640 may intercept a communication that would have triggered the display of a notification, and prevent the notification from being displayed (e.g., by overriding instructions to display the notification and modifying such instructions to prevent the notification from being displayed). In embodiments, the notification suppression engine 640 may suppress the notification in some other manner (e.g., by modifying the notification by concealing sensitive text as determined using natural language techniques, concealing sensitive images based on criteria defining what constitutes sensitive images, etc.).

In embodiments the notification suppression engine 640 may output a status of the notification suppression mode (e.g., to application server 230) so that users may view that status from an application (e.g., an instant messaging application). In embodiments, the notification suppression engine 640 may present the status of the notification suppression mode within a system tray or other location on the user device 210 so that the user device 210 is made aware of the status and provide the user with an opportunity to manually override or change the status of the notification suppression mode (e.g., manually activate, pause, or deactivate the notification suppression mode).

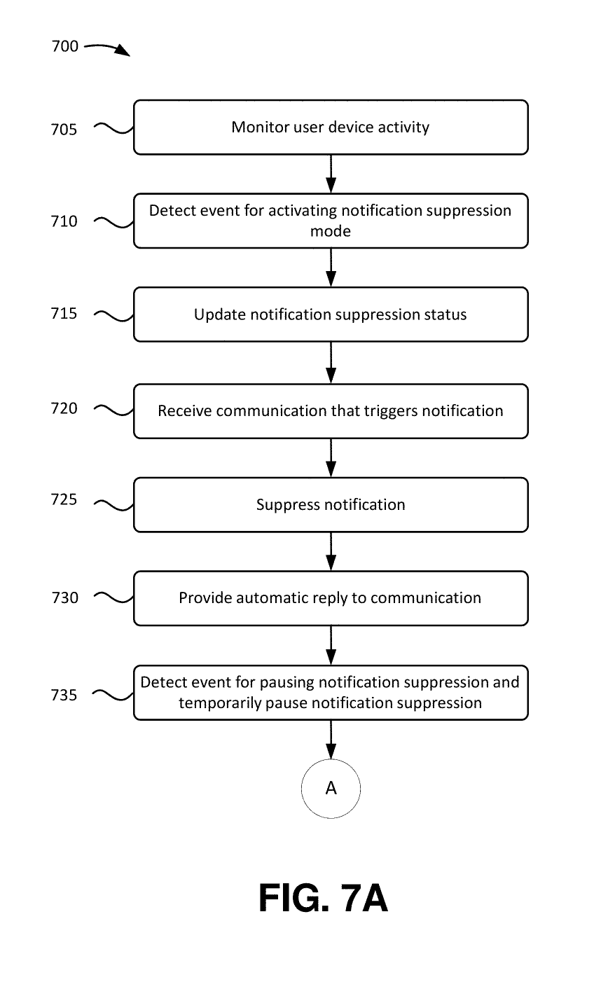

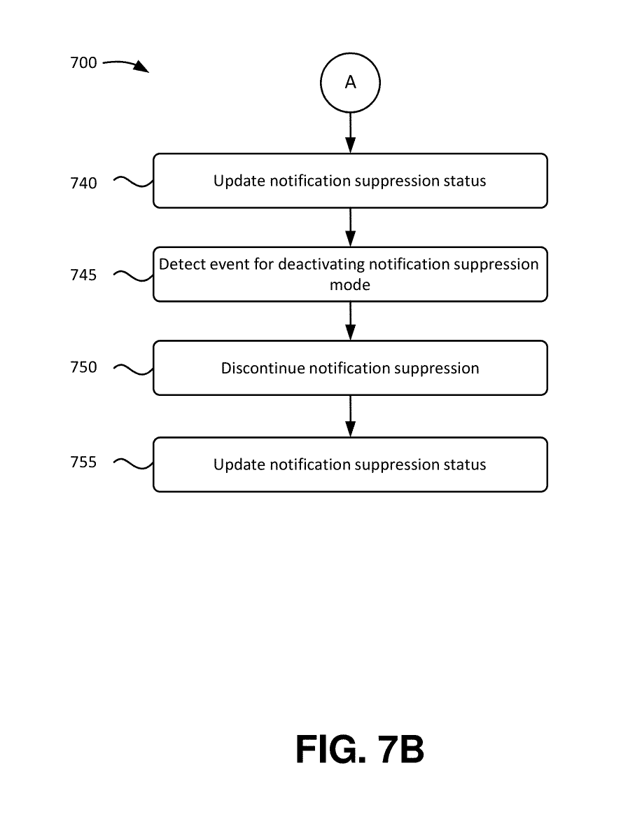

FIGS. 7A and 7B show an example flowchart of a process for automatically activating, pausing, and deactivating a notification suppression mode without user interaction. The steps of FIG. 7 may be implemented in the environment of FIG. 5, for example, and are described using reference numbers of elements depicted in FIG. 5. As noted above, the flowchart illustrates the architecture, functionality, and operation of possible implementations of systems, methods, and computer program products according to various embodiments of the present invention.

As shown in FIG. 7, process 700 may include monitoring user device activity (step 705). For example, as described above with respect to the activity monitoring module 610 the notification suppression component 215 may monitor device activity of user device 210. In embodiments, the notification suppression component 215 may monitor the type and/or model number of a display through which content is being output, application activity, such as the presentation mode status of a presentation application, imaging data received from one or more camera devices of user device 210 mouse and/or keyboard inputs of user device 210, etc. In embodiments, the notification suppression component 215 may continue to monitor the user device activity throughout process 700.

Process 700 may also include detecting an event for activating a notification suppression mode (step 710). For example, as described above with respect to the suppression event detection module 630, the notification suppression component 215 may detect that the notification suppression mode should be activated based on comparing device activity monitoring information (e.g., from the activity monitoring module 610) with the criteria stored by the suppression event criteria repository 620 that stipulate the conditions under which the notification suppression mode should be activated. As an illustrative example, the notification suppression component 215 may identify that content is being displayed through an interface assigned to a projector or through a display having a model number as a projector. Further, the notification suppression component 215 may identify (e.g., based on information stored by the suppression event criteria repository 620) that the notification suppression mode should be activated when content is being displayed through an interface assigned to a projector or through a display having a model number as a projector. Accordingly, the notification suppression component 215 may detect a suppression event in which the notification suppression mode should be activated.

In embodiments, other events for activating notification suppression maybe detected. For example, user/device activity with expiration times may trigger notification suppression. As an example, applications or webpages in which completion of forms/transaction information tasks must be completed within a certain amount of time may trigger notification suppression. In embodiments, the notification suppression component 215 may identify when the device activity corresponds to user interaction with a time-based application or time-based web page, or other activity having an expiration time. In this way, notifications may be suppressed to prevent distractions that may delay the user from completing forms or other activity that may expire within a certain period of time. In embodiments, other events for activating notification suppression maybe detected other than those described herein.

Process 700 may further include updating a notification suppression status (step 715). For example, as described above with respect to the notification suppression engine 640, the notification suppression component 215 may update a notification suppression status to “active” and may provide the notification suppression status to an application server 230. The application server 230 may publish the notification suppression status which may be viewed through an application by other users (e.g., an instant messaging application or the like). In embodiments, the suppression notification status may also be viewable within a system tray or other location within a user interface presented by the user device 210.

Process 700 may also include receiving a communication that triggers a notification (step 720). For example, as described above with respect to the notification suppression engine 640, the notification suppression component 215 may receive a notification that triggers a notification (e.g., an e-mail message, text message, instant message, etc.). The notification suppression component 215 may intercept a communication that would have triggered the display of a notification on the user device 210.

Process 700 may further include suppressing the notification (step 725). For example, as described above with respect to the notification suppression engine 640, the notification suppression component 215 may suppress the notification by preventing the notification from being displayed on the user device 210 (e.g., by overriding instructions to display the notification and modifying such instructions to prevent the notification from being displayed). In embodiments, the notification suppression component 215 may suppress the notification in some other manner (e.g., by modifying the notification by concealing sensitive text as determined using natural language techniques, concealing sensitive images based on criteria defining what constitutes sensitive images, etc.). In embodiments, the notification suppression component 215 may store the notification in a log that may be retrieved later via user instruction (e.g., to permit the user to view a list of communications for which the notifications were suppressed).

Process 700 may also include providing an automatic reply to the communication (step 730). For example, the notification suppression component 215 may provide an automatic reply to a sender of the communication based on suppressing a notification for the communication. In embodiments, the automatic reply may be user customizable or preconfigured. The automatic reply may include text indicating the recipient may not be immediately available or that the user is not currently receiving notifications to incoming communications.

Process 700 may further include detecting an event for pausing notification suppression and temporarily pausing the notification suppression (step 735). For example, as described above with respect to the suppression event detection module 630, the notification suppression component 215 may detect a suppression event defining when the notification suppression mode should be paused based on comparing device monitoring information (from activity monitoring module 610 and step 705) with criteria information (from the suppression event criteria repository 620) and detecting when the device monitoring information satisfies the criteria for pausing the notification suppression mode. In embodiments, after pausing the notification suppression mode, the notification suppression component 215 may resume or reactive the notification suppression mode after a threshold period of time and/or based on other user device activity (e.g., the resuming of a presentation mode in a presentation application).

Referring to FIG. 7B, process 700 may also include updating the notification suppression status (step 740). For example, as described above with respect to the notification suppression engine 640, the notification suppression component 215 may update the notification suppression status when the notification suppression mode transitions to a “paused” status. The notification suppression component 215 may also update the notification suppression status when the notification suppression mode transitions from the “paused” status to an “active” status.

Process 700 may further include detecting an event for deactivating the notification suppression mode (step 745). For example, as described above with respect to the suppression event detection module 630, the notification suppression component 215 may detect an event for deactivating the notification suppression mode. As described herein, the notification suppression component 215 may detect a suppression event defining when the notification suppression mode should be deactivated based on comparing device monitoring information (from activity monitoring module 610) with criteria information (from the suppression event criteria repository 620) and detecting when the device monitoring information satisfies the criteria for deactivating the notification suppression mode. As an example, the notification suppression component 215 may detect the event for deactivating the notification suppression mode when the conditions under which the notification suppression mode was activated are no longer true (e.g., when content is no longer displayed through an interface assigned to a projector display, when content is no longer displayed via an external display of a particular type/model number, etc.).

Process 700 may also include discontinuing notification suppression (step 750). For example, as described above with respect to the notification suppression engine 640, the notification suppression component 215 may discontinue notification suppression by providing notifications for incoming communications that trigger a notification.

Process 700 may further include updating a notification suppression status (step 755). For example, as described above with respect to the notification suppression engine 640, the notification suppression component 215 may update a notification suppression status to “disabled” or “deactivated” which would correspond to a status indicating that the user is available and receiving notifications for incoming communications.

As described herein, aspects of the present invention improve privacy and security of sensitive information by preventing communication notifications having private and/or sensitive matter from being abruptly displayed when other individuals (aside from the intended recipient of the communication) are viewing content displayed by user device 210. In embodiments, notifications may be suppressed altogether. Alternatively, notifications may be modified so as to conceal any sensitive information.

In embodiments, the notifications may be suppressed without requiring the user to manually set a suppression mode. For example, the suppression mode may be set automatically based on user device activity and/or other the detection of other criteria, as described herein. Further, existing applications need not be re-written or updated since aspects of the present invention may toggle the suppression mode based on normal user activity and without receiving any special or specific instructions from applications or operating systems.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
monitoring, by a user device, activity associated with the user device;
detecting, by the user device, an event for activating a notification suppression mode based on the monitoring, wherein the event relates to viewing of content displayed by the user device by another user other than a primary user of the user device;
receiving, by the user device, a communication; and
suppressing, by the user device, a notification for the communication based on the detecting the event for activating the notification suppression mode.

2. The method of claim 1, further comprising:
detecting, by the user device, an event for deactivating the notification suppression mode based on the monitoring;
receiving a subsequent communication after detecting the event for deactivating the notification suppression mode; and
displaying a notification for the subsequent notification based on the detecting the event for deactivating the notification suppression mode and receiving the subsequent notification.

3. The method of claim 2, further comprising:
updating a status of the notification suppression mode;
displaying the status within a user interface of the user device; and
outputting the status to an application server.

4. The method of claim 1, wherein the monitoring the activity associated with the user device includes monitoring at least one selected from the group consisting of:
application activity;
a video interface through which content is displayed by the user device;
screen sharing activity; and
full-screen or presentation mode status of an application of the user device.

5. The method of claim 4, wherein the detecting the event for activating the notification suppression mode includes detecting at least one selected from the group consisting of:
determining that content is being displayed through a video interface associated with an external display;
determining that content is being displayed through a display having a type or model number;
determining that content is being displayed in a full-screen or presentation mode.

6. The method of claim 1, wherein the monitoring the activity associated with the user device includes monitoring image data received from one or more camera devices connected to the user device.

7. The method of claim 6, wherein the detecting the event for activating the notification suppression mode includes detecting that a non-primary user is viewing a display through which content is displayed by the user device.

8. The method of claim 7, wherein the detecting that the non-primary user is viewing the display is based on facial recognition techniques.

9. The method of claim 1, further comprising providing an automatic reply to the communication based on receiving the communication.

10. The method of claim 1, wherein the suppressing the notification includes concealing sensitive or private information in the notification and displaying the notification with the sensitive or private information being concealed.

11. The method of claim 1, wherein the suppressing the notification includes overriding instructions to display the notification.

12. The method of claim 1, wherein a service provider at least one of creates, maintains, deploys and supports the computing device.

13. The method of claim 1, wherein the monitoring the activity, the detecting the event, the receiving the communication, and the suppressing the notification are provided by a service provider on a subscription, advertising, and/or fee basis.

14. The method of claim 1, further comprising deploying a system for suppressing notifications, comprising providing a computer infrastructure operable to perform the monitoring the activity, the detecting the event, the receiving the communication, and the suppressing the notification.

15. A computer program product for suppressing notifications, the computer program product comprising a computer readable storage medium having program instructions embodied therewith, the program instructions executable by a computing device to cause the computing device to:
monitor activity associated with the user device;
detect, without user interaction, an event for suppressing notifications based on the monitoring, wherein the event relates to viewing of content displayed by the user device by another user other than a primary user of the user device;
receive a communication; and
suppress a notification for the communication based on the detecting the event for suppressing notifications.

16. The computer program product of claim 15, wherein the notification is a pop-up notification.

17. The computer program product of claim 15, wherein the detecting the event for suppressing the notifications includes detecting at least one selected from the group consisting of:
determining that content is being displayed through a particular video interface;
determining that content is being displayed through a display having a particular type or model number;
determining that content is being displayed in a full-screen or presentation mode; and
determining that activity associated with the user device corresponds to an activity with an expiration time.

18. The computer program product of claim 15, wherein the notification includes sensitive or private information.

19. A system comprising:
a CPU, a computer readable memory and a computer readable storage medium associated with a user device;
program instructions to monitor imaging data from one or more camera devices connected to the user device;
program instructions to detect that a non-primary user is viewing a display through which the user device is displaying content; and
program instructions to suppress notifications of incoming communications based on detecting that the non-primary user is viewing the display;
wherein the program instructions are stored on the computer readable storage medium for execution by the CPU via the computer readable memory.

20. The system of claim 19, wherein the incoming communications include at least one selected from the group consisting of:
e-mail messages;
instant messages; and
text messages.
